(19) United States
(12) Patent Application Publication
(10) Pub. No.: US 2026/0359655 A1
(43) Pub. Date: Nov. 12, 2026

(54) METHOD FOR AUTOMATICALLY GENERATING TRAINING EMAIL SUBJECTS USING REINFORCEMENT LEARNING

(71) Applicant: CheckMAL Inc., Gyeonggi-do (KR)

(72) Inventor: Hwan Gui CHOI, Gyeonggi-do (KR)

(73) Assignee: CheckMAL Inc., Gyeonggi-do (KR)

(21) Appl. No.: 19/673,237

(22) Filed: May 11, 2026

(30) Foreign Application Priority Data
May 12, 2025 (KR) 10 2025 0061333

(51) Int. Cl. G06N 3/092; H04L 51/02

(52) U.S. Cl. CPC G06N 3/092; H04L 51/02

(57) ABSTRACT

The present specification relates to a method for performing reinforcement learning to generate a topic for a training email by a server, the method including: obtaining a user state through a database, the user state including characteristic information of a user to whom the training email is delivered; inputting the state into a reinforcement learning model (Q-Network); and determining a policy of the reinforcement learning model and recommending a topic for the training email.

### BACKGROUND

This specification relates to the field of artificial intelligence (AI) and security technology, and relates to a method for selecting an optimal training email topic, considering user preference, timeliness, and social interest, by applying Deep Reinforcement Learning.

Existing training email systems rely on static topic selection methods. It is common practice that experts directly analyze the latest issue emails to select topics, or use regular issues such as year-end tax settlements or summer vacations as topics. Additionally, while new topics are sometimes selected based on email topics that users frequently clicked on in the past, this approach has limitations in responding to changes in user interests or the latest threats.

Phishing email attacks are evolving rapidly, and there is a high probability that entirely new types of phishing emails will emerge. Existing systems are not updated until experts encounter and analyze the latest phishing email information, which may delay responses to new threats. This structure increases the risk of users being exposed to the latest phishing attacks.

Existing training email systems primarily performed static recommendations based on past click-through rates. This makes it difficult to reflect real-time changes in user interests or the latest security issues. Consequently, it is difficult to select topics that users are actually interested in, and user engagement may decrease as standardized training topics are repeated.

### SUMMARY

This specification is to provide an adaptive reinforcement learning-based method for selecting a customized email topic by learning the individual preferences and behavioral patterns of users.

Furthermore, this specification is to implement an algorithm for selecting a topic that dynamically evaluates and reflects the timeliness, importance, and social interest of emails.

The technical aspects to be achieved by this specification are not limited to the technical aspects mentioned above, and other technical aspects not mentioned will be clearly understood by those skilled in the art to which this specification pertains from the detailed description of the specification below.

As an aspect of the present specification, a method for performing reinforcement learning to generate a topic for a training email by a server may include: obtaining a user state through a database, the user state including characteristic information of a user to whom the training email is delivered; inputting the state into a reinforcement learning model (Q-Network); and determining a policy of the reinforcement learning model and recommending a topic for the training email.

In addition, the method may include measuring a reward based on the topic of the training email, wherein the reward is determined in relation to the user's feedback; and updating the reinforcement learning model based on the reward.

In addition, the policy of the reinforcement learning model may be based on a ε-greedy policy.

In addition, the policy of the reinforcement learning model may recommend a random topic with probability ε and recommend the topic with the highest Q value with probability (1−ε).

In addition, the updating of the reinforcement learning model based on the reward may include: storing the user's response as an experience in a replay memory based on the reward; mini-batch sampling the experience using the replay memory; and updating the reinforcement learning model based on the mini-batch sampling.

In addition, the method may further include: generating content for the training email using the topic of the recommended training email; and generating the training email based on the content.

In addition, the measuring of the reward based on the topic of the training email may further include determining the weight of the reward based on user information or environment information.

As an aspect of the present specification, a server performing reinforcement learning to generate a topic for a training email may include: a communication module; a memory; and a processor that is for functionally controlling the communication module and the memory, wherein the processor obtains a user state through a database, the user state including characteristic information of a user to whom the training email is delivered, inputs the state into a reinforcement learning model (Q-Network), determines a policy of the reinforcement learning model, and recommends a topic for the training email.

According to an embodiment of this specification, it is possible to provide an adaptive reinforcement learning-based method for selecting a customized email topic by learning the individual preferences and behavioral patterns of users.

Furthermore, it is possible to implement an algorithm for selecting a topic that dynamically evaluates and reflects the timeliness, importance, and social interest of emails.

The effects obtainable from this specification are not limited to the effects mentioned above, and other effects not mentioned will be clearly understood by those skilled in the art to which this specification pertains from the description below.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device related to this specification;

FIG. 2 is a block diagram of an AI device according to an embodiment of this specification;

FIG. 3 illustrates an automatic training email generation system to which this specification is applicable;

FIG. 4 is an example of a reinforcement learning system to which this specification is applicable;

FIG. 5 illustrates a reinforcement learning method of a reinforcement learning module to which this specification is applicable;

FIG. 6 illustrates a reinforcement learning algorithm to which this specification is applicable;

FIG. 7 illustrates a reward function to which this specification is applicable; and

FIG. 8 illustrates a method for automatically generating a training email to which this specification is applicable.

FIG. 9 illustrates an example of a training email to which this specification is applicable.

### DETAILED DESCRIPTION

Hereinafter, embodiments disclosed in this specification will be described in detail with reference to the accompanying drawings, wherein identical or similar components are assigned the same reference numerals regardless of drawing symbols, and redundant descriptions thereof will be omitted. The suffixes “module” and “unit” for components used in the following description are given or used interchangeably only for ease of specification drafting, and do not have meanings or roles that are distinct from each other per se. In addition, in describing the embodiments disclosed in this specification, when it is determined that a detailed description of related known technology may obscure the gist of the embodiments disclosed in this specification, the detailed description thereof will be omitted. In addition, the accompanying drawings are only for facilitating easy understanding of the embodiments disclosed in this specification, and the technical ideas disclosed in this specification are not limited by the accompanying drawings, and it should be understood to include all changes, equivalents, and substitutes included in the spirit and technical scope of this specification.

Terms including ordinal numbers such as first, second, etc. may be used to describe various components, but the components are not limited by the terms. The terms are used only for distinguishing one component from another component.

When a component is referred to as being “connected” or “coupled” to another component, it should be understood that it may be directly connected or coupled to the other component, while other components may also exist in between. On the other hand, when a component is referred to as being “directly connected” or “directly coupled” to another component, it should be understood that no other components exist in between.

The singular expression includes the plural expression, unless the context clearly indicates otherwise.

In this application, terms such as “include” or “have” are intended to designate that the features, numbers, steps, operations, components, parts, or combinations thereof described in the specification are present, and should be understood as not precluding in advance the presence or possibility of addition of one or more other features, numbers, steps, operations, components, parts, or combinations thereof.

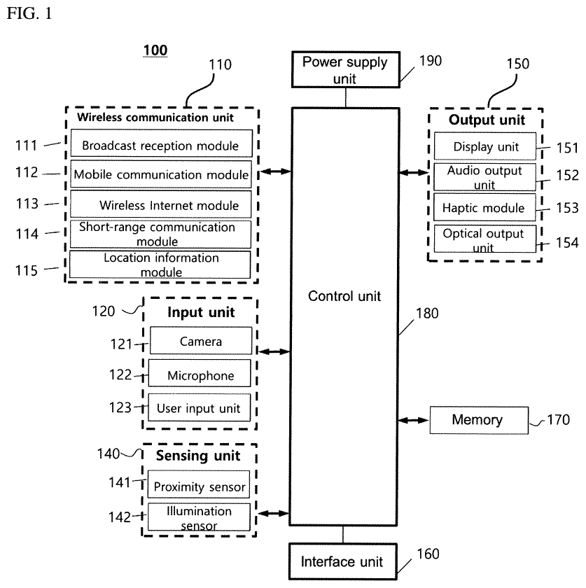

FIG. 1 is a block diagram illustrating an electronic device related to this specification.

The electronic device 100 may include a wireless communication unit 110, an input unit 120, a sensing unit 140, an output unit 150, an interface unit 160, a memory 170, a control unit 180, and a power supply unit 190. The components illustrated in FIG. 1 are not essential for implementing the electronic device, and thus the electronic device described herein may include more or fewer components than those listed above.

More specifically, among the components, the wireless communication unit 110 may include one or more modules that enable wireless communication between the electronic device 100 and a wireless communication system, between the electronic device 100 and another electronic device 100, or between the electronic device 100 and an external server. Furthermore, the wireless communication unit 110 may include one or more modules that connect the electronic device 100 to one or more networks.

The wireless communication unit 110 may include at least one of a broadcast reception module 111, a mobile communication module 112, a wireless Internet module 113, a short-range communication module 114, and a location information module 115.

The input unit 120 may include a camera 121 or video input unit for video signal input, a microphone 122 or audio input unit for audio signal input, and a user input unit (123, e.g., a touch key, a mechanical key, etc.) for receiving information from the user. Voice data or image data collected by the input unit 120 may be analyzed and processed into user control commands.

The sensing unit 140 may include one or more sensors for sensing at least one of information within the electronic device, information about the surrounding environment surrounding the electronic device, and user information. For example, the sensing unit 140 may include at least one of a proximity sensor 141, an illumination sensor 142, a touch sensor, an acceleration sensor, a magnetic sensor, a gravity sensor (G-sensor), a gyroscope sensor, a motion sensor, an RGB sensor, an infrared sensor (IR sensor), a fingerprint recognition sensor, an ultrasonic sensor, an optical sensor (e.g., a camera (see 121)), a microphone (see 122), a battery gauge, an environmental sensor (e.g., a barometer, a hygrometer, a thermometer, a radiation detection sensor, a heat detection sensor, a gas detection sensor, etc.), or a chemical sensor (e.g., an electronic nose, a healthcare sensor, a biometric sensor, etc.). Meanwhile, the electronic device disclosed herein may utilize information sensed by at least two or more of these sensors in combination. The output unit 150 is to generate output related to visual, auditory, or tactile sensations and may include at least one of a display unit 151, an audio output unit 152, a haptic module 153, and an optical output unit 154. The display unit 151 may be formed as a touch screen by forming a layered structure with a touch sensor or forming an integrated structure. This touch screen functions as a user input unit 123 that provides an input interface between the electronic device 100 and the user, while also providing an output interface between the electronic device 100 and the user.

The interface unit 160 serves as a path for various types of external devices connected to the electronic device 100. The interface unit 160 may include at least one of a wired/wireless headset port, an external charger port, a wired/wireless data port, a memory card port, a port for connecting a device equipped with an identification module, an audio input/output (I/O) port, a video input/output (I/O) port, and an earphone port. The electronic device 100 may perform appropriate control related to the connected external device in response to the external device being connected to the interface unit 160.

Furthermore, the memory 170 stores data supporting various functions of the electronic device 100. The memory 170 may store data and instructions for the operation of the electronic device 100, and a number of application programs (or applications) running on the electronic device 100. At least some of these application programs may be downloaded from an external server through wireless communication. Additionally, at least some of these applications may be present on the electronic device 100 from the time of shipment for the basic functions of the electronic device 100 (e.g., incoming and outgoing calls, message reception and transmission). Meanwhile, the application programs are stored in the memory 170, installed on the electronic device 100, and driven by the control unit 180 to perform the operations (or functions) of the electronic device.

In addition to the operations related to the application programs, the control unit 180 typically controls the overall operation of the electronic device 100. The control unit 180 processes signals, data, and information input or output through the components described above, or runs application programs stored in the memory 170, thereby providing or processing appropriate information or functions to the user.

Furthermore, the control unit 180 may control at least some of the components described with reference to FIG. 1 to run the application programs stored in the memory 170. Furthermore, the control unit 180 may operate at least two or more of the components included in the electronic device 100 in combination to run the application programs.

The power supply unit 190, under the control of the control unit 180, receives external or internal power and supplies power to each component included in the electronic device 100. The power supply unit 190 includes a battery, and the battery may be an embedded battery or a replaceable battery.

At least some of the components may operate cooperatively to implement the operation, control, or control method of an electronic device according to the various embodiments described below. Furthermore, the operation, control, or control method of the electronic device may be implemented on the electronic device by executing at least one application program stored in the memory 170.

In this specification, the electronic device 100 may be collectively referred to as a server, and the server may include a cloud server. Furthermore, the terminal may include all or part of the electronic device 100 and may include a tablet PC.

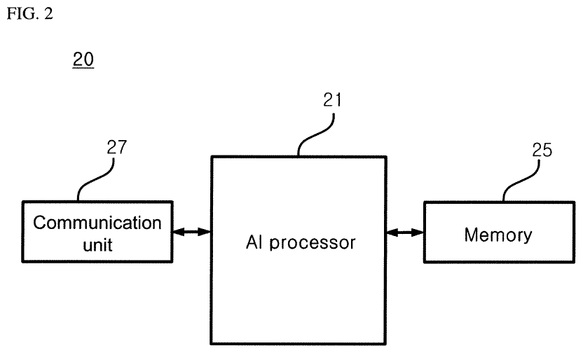

FIG. 2 is a block diagram of an AI device according to an embodiment of this specification.

The AI device 20 may include an electronic device including an AI module capable of performing AI processing, or a terminal including the AI module. Furthermore, the AI device 20 may be included as part of at least a portion of the electronic device 100 illustrated in FIG. 1 and configured to perform at least a portion of the AI processing.

The AI device 20 may include an AI processor 21, memory 25, and/or a communication unit 27.

The AI device 20, which is a computing device capable of learning a neural network, may be implemented in various electronic devices, such as a terminal, desktop PC, laptop PC, or tablet PC.

The AI processor 21 may learn a neural network using a program stored in the memory 25. In particular, the AI processor 21 may automatically select a training email topic based on reinforcement learning and generate an artificial intelligence model that learns user responses to optimize the email content.

For example, the AI processor 21 may analyze user characteristics, national and generational trends, and the latest security threat data to automatically select a training email topic, and may learn user responses (views, clicks, etc.) in real time through a reinforcement learning algorithm to continuously optimize the most effective topic. Furthermore, the AI processor may utilize LLM to automatically generate an email subject and body appropriate to the topic and provide an optimized message to the user using a designated prompt.

User response data (e.g., open rates, click-through rates, response times, etc.) may be collected and analyzed by the AI processor 21, and may be reflected in the reinforcement learning algorithm to improve performance when generating the next training email. In particular, rewards are calculated based on user responses to automatically learn optimal topics and content, and the generated emails are automatically converted into electronic mail (EML) files and provided in a format optimized for email clients (e.g., Outlook, Gmail, etc.).

During this process, the effectiveness of the training emails is maintained by incorporating the security rules of each email client. Through this automated process, the AI processor 21 can enhance the efficiency of the training email system and provide an intelligent security training system capable of quickly responding to the latest phishing techniques.

Meanwhile, the AI processor 21, which performs the functions described above, may be a general-purpose processor (e.g., a CPU), but it may also be a dedicated AI processor for AI learning (e.g., a GPU, graphics processing unit).

The memory 25 may store various programs and data required for the operation of the AI device 20. The memory 25 may be implemented as non-volatile memory, volatile memory, flash memory, a hard disk drive (HDD), or a solid-state drive (SDD). The memory 25 is accessed by the AI processor 21, and data may be read/written/modified/deleted/updated by the AI processor 21. Furthermore, the memory 25 may store a neural network model (e.g., a deep learning model) generated through a learning algorithm for data classification/recognition according to one embodiment of the present disclosure.

Meanwhile, the AI processor 21 may include a data learning unit that trains a neural network for data classification/recognition. For example, the data learning unit may acquire learning data to be used for learning and train the deep learning model by applying the acquired learning data to the deep learning model.

The communication unit 27 may transmit the AI processing results generated by the AI processor 21 to an external electronic device.

Here, the external electronic device may include another terminal and/or a server.

Meanwhile, although the AI device 20 illustrated in FIG. 2 is functionally divided into an AI processor 21, memory 25, and communication unit 27, the aforementioned components may be integrated into a single module, referred to as an AI module or artificial intelligence (AI) model.

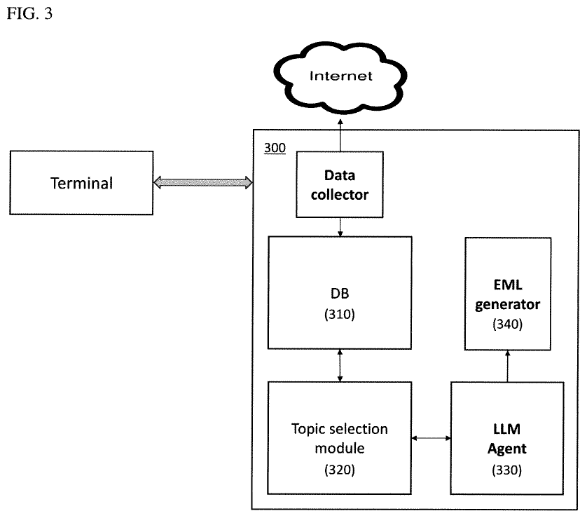

FIG. 3 illustrates an automatic training email generation system to which this specification is applicable.

Referring to FIG. 3, the automatic training email generation system 300 described herein may be implemented as a physical server or cloud server and include a data collector, a database 310, a topic selection module 320, an LLM agent 330, and an Emi generator 340.

The data collector may collect data in real time from various sources (e.g., websites, social media, news, blogs, etc.) on the Internet. For example, this module may automatically collect the latest security issues, phishing techniques, and user interest topics required for training email generation, and continuously update the database 310 with information necessary for topic selection and email generation. The collected data may be refined and stored in the database 310.

Furthermore, the data collector may be configured to collect customized data based on the user's specific interests or the profile of the training subject. For example, for users in the financial sector, information on the latest financial fraud techniques may be collected first, or for users in a specific country, the latest security threats occurring in that country may be prioritized.

The DB 310 is a database module that stores and manages data collected by the data collector. This DB 310 may store various information for generating training emails in a structured format and categorize and manage the collected data by user characteristics, latest security threats, trends, etc. This data may include phishing-related data, user response data (e.g., open rates, click-through rates), and user feedback data. Furthermore, the database 310 may be linked to the topic selection module 320 to provide data necessary for the reinforcement learning-based topic selection process. For example, email topics with high click-through rates for a specific user group may be used as training data for priority selection in reinforcement learning, contributing to the continuous improvement of the performance of the training system 300.

The topic selection module 320 may automatically select the most effective training email topic for a user based on data provided from the database 310. This module applies a reinforcement learning algorithm to learn user response data in real time and dynamically determines customized topics for each user group. The topic selection module 320 may select the optimal topic by reflecting user characteristics (e.g., country, occupation, age, etc.), recent trends, and security threats. Furthermore, the topic selection module 320 evaluates topic performance based on user response (e.g., open rate, click-through rate, etc.), and topics with high performance may receive higher rewards through reinforcement learning, increasing their likelihood of being selected first. This module also passes the selected topic to the LLM agent 330 to facilitate email generation.

The LLM agent 330 may utilize large-scale language models such as Llama, GPT, and Deep Seek to generate training email content tailored to the topics received from the topic selection module. This module may automatically generate an email subject and body optimized for the user through specified prompts, and provide customized messages that reflect the user's characteristics and current issues. The LLM agent 330 may generate training email text as well as images, links, and interactive elements, and may generate optimized content for seamless use in various email clients (e.g., Outlook, Gmail, etc.). The generated email content is delivered to the EML generator 340.

The EML generator 340 is a module that converts the email content generated by the LLM agent 330 into an EML file format to generate the final training email. The EML file is a standard format usable by email clients and may include the email subject, body, image, link, etc. Furthermore, the EML generator 340 may include links or images to track user responses, enabling training performance measurement. The generated EML file is delivered to the user, and the system 300 performance may be continuously improved based on customer feedback.

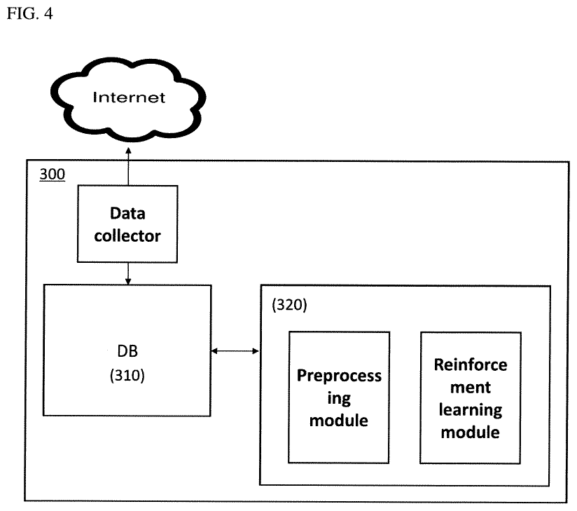

FIG. 4 is an example of a reinforcement learning system to which this specification is applicable.

Reinforcement learning is a learning method that enables an agent to learn optimal actions by interacting with an environment. The agent selects an action in a specific situation (state) and may receive a reward as a result. To maximize this reward, the agent learns through experience and may acquire the optimal behavioral pattern over time.

Referring to FIG. 4, the topic selection module 320 may include a preprocessing module and a reinforcement learning module for reinforcement learning.

The preprocessing module may perform the role of converting data stored in the DB 310 into a form that may be learned by a reinforcement learning model. The preprocessing module may extract features such as user characteristics (job function, years of experience, etc.), click time information, and clicked topics from user click data, and may identify keywords related to the latest issues from social trend data and convert them into topic vectors.

In addition, the preprocessing module also performs data quality management, such as data cleaning, removal of duplicates, and deletion of unnecessary information. For example, incorrect click records or duplicate data are filtered out from user click data to prevent interference with learning. The preprocessed data is transformed into State, Action, and Reward formats that may be used by the reinforcement learning module.

The reinforcement learning module may automatically generate optimal training email topics based on user behavior patterns and the latest trend data. This module recommends training topics using a reinforcement learning algorithm (DQN, Deep Q-Network) and may present the optimal topic to a user by calculating the Q-value (predicted click rate) for each topic.

For instance, the reinforcement learning module selects a topic (Action) based on the initial State, evaluates the reward based on whether the user clicks (Reward), and predicts the optimal topic through the Q-Network. Subsequently, the reinforcement learning module updates the replay memory using user click data and optimizes the performance of the AI model through learning.

The reinforcement learning module learns in real-time and may continuously improve the performance of recommended topics based on user feedback. This allows for the immediate reflection of the latest phishing attacks or user interests.

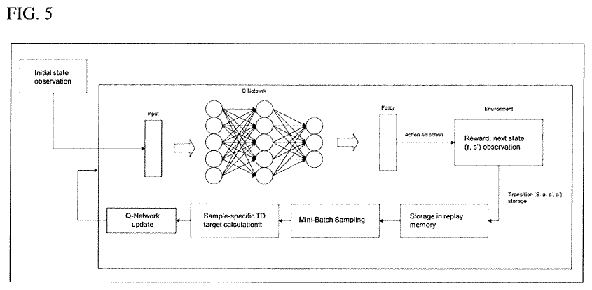

FIG. 5 illustrates a reinforcement learning method of a reinforcement learning module to which this specification is applicable.

A reinforcement learning environment may refer to a space where an agent can perform learning through interaction.

Referring to FIG. 5, the reinforcement learning module may configure a reinforcement learning environment to perform optimal topic recommendations that reflect user behavior patterns and the latest trends.

For example, the reinforcement learning environment may be configured as follows:
\textcircled{1} State
   User Characteristics: Reflects individual user characteristics such as job function, years of experience, region, and gender.
   Issue Characteristics: Reflects topic clustering results regarding currently popular issues, the latest phishing topics, and social trends.
   Temporal Context: Year, season, specific event period (e.g., year-end tax settlement, summer vacation, etc.)
   Social Trends: Latest news, community issues, trend data collected from social media
   Diversity Metrics: Duplication rate of recently recommended topics, prevention of repeated topic recommendations
\textcircled{2} Action
   Topic Selection: Selects topics for training emails, enabling topic recommendations that reflect user characteristics and current issues.
   Diversity Adjustment: Minimizes repetition of the same topic by controlling the range and variation of recommended topics.
\textcircled{3} Reward
   Engagement: Grants a positive reward (+1) when the user clicks or opens the email.
   Interaction: Provides additional rewards when the user clicks a link within the email.
   Diversity: Diversity: Rewards increase as the repetition of the same topic decreases, and weights increase as diversity increases.
   Timeliness: Topics related to recent issues allow higher rewards (e.g., year-end tax settlement topics during the year-end tax settlement season).
\textcircled{4} Environment
   User Behavior: Whether the user clicks on an email, whether they read the email content, etc.
   News Trend API: Collects data related to the latest news, social media trends, and phishing attacks.
   Phishing Campaign Statistics: Statistics on the latest phishing attack cases and user responses
\textcircled{5} Q-Network (reinforcement learning model)
   Q-Network (Deep Q-Network, DQN): Calculates the predicted probability of a click (Q-value) for each topic (behavior) based on the user's state.
   Policy: Performs topic selection based on Q-values using an ε-greedy approach, where the ε value balances exploration (random topic recommendation) and exploitation (optimal topic recommendation).

The reinforcement learning module may automatically generate topics through the configured reinforcement learning environment.

As described above, the reinforcement learning environment may be designed to recommend topics optimized for the user by reflecting user behavior patterns and the latest trends in real time. For example, the reinforcement learning module may predict the probability of clicking on each topic in a Q-Network based on the user's state and recommend topics to the user according to a policy.

The reinforcement learning module may continuously improve topic recommendation performance by comprehensively analyzing various data, such as user characteristics, temporal context, social trends, and the latest phishing topics. By observing the initial state, user characteristics (job function, years of experience, region, etc.) and the latest issues may be identified and input into the Q-Network to calculate the Q-value for each topic (behavior). For example, during the year-end tax settlement season, the Q-value of related topics may increase, which allows for the automatic recommendation of topics that the user is more likely to click on frequently.

Furthermore, through the E-greedy policy, the reinforcement learning module may maintain a balance between exploration (random topic recommendation) and exploitation (optimal topic recommendation). The ε value is set high during the initial stages of the reinforcement learning module's training to explore various topics, and as training progresses, it gradually decreases to focus recommendations on the optimal topic. This enables the reinforcement learning module to learn increasingly efficiently through user response data.

User actions (e.g., clicking, viewing, link clicking) are stored as feedback for the reinforcement learning module for learning therefrom, and the data stored in the replay memory may be utilized for Q-Network learning through mini-batch sampling. This allows the reinforcement learning module to continuously improve training performance by repeatedly learning user responses. The Q-Network may predict the optimal topic by learning user behavior patterns and maintain training stability through the Target Network.

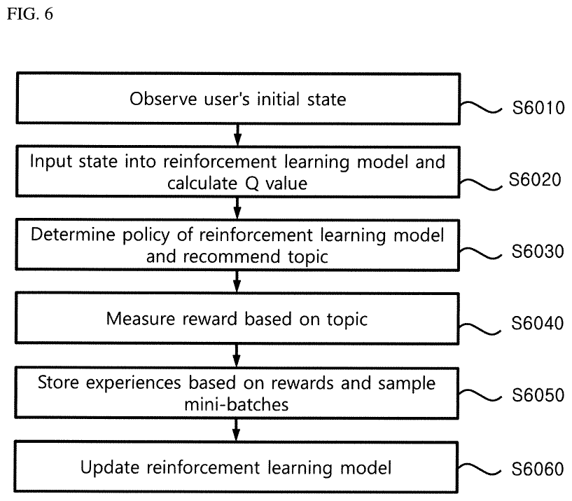

FIG. 6 illustrates a reinforcement learning algorithm to which this specification is applicable.

Referring to FIG. 6, the reinforcement learning algorithm of the reinforcement learning module is illustrated in more detail to automatically generate user-customized training email topics as described in FIG. 5.

The reinforcement learning module observes the user's initial state S6010.

The reinforcement learning module observes the user's state through the DB. The system defines the current state based on user characteristics, time information, social trends, issue characteristics, and diversity indicators. User characteristics may include job function, years of experience, region, gender, etc. Time information may reflect that user interest topics may change over time based on the year, season, or specific event periods (e.g., year-end tax settlement, summer vacation, etc.). Additionally, social trends may reflect user interests in real time by including the latest news, community issues, and trend data collected from social media. Issue characteristics refer to the clustering results of the latest phishing topics or social issues, enabling the user to learn about the latest threats. Diversity metrics may be used to prevent repeated topic recommendations by evaluating the duplication rate of recently recommended topics. Accordingly, the reinforcement learning module may identify the user and the current environment, and the observed state information may be delivered to a reinforcement learning model (Q-Network).

The reinforcement learning module inputs the state into the reinforcement learning model (Q-Network) and calculates the Q value S6020.

The reinforcement learning module inputs the observed state vector into the Q-Network. The Q-Network is a Deep Neural Network that may calculate a Q value for each state based on topic selection (action). For example, the Q value quantifies the probability that each topic will be clicked by the user, enabling the system to recommend the optimal topic.

If the state is “Year-end tax settlement season, Job function: Office worker,” the Q-Network may calculate the following Q values:
Q(s, a1)=0.77 (Year-end tax settlement related phishing topic)
Q(s, a2)=0.1 (Hacking email warning topic)

In this case, the Q value reflects the user's interest or click probability, and a higher Q value may indicate that the corresponding topic is more attractive to the user. Q-Networks may predict these Q-values with increasing accuracy through training and continuously improve performance using user click data. For example, Q-Network training may be performed based on a loss function, and as the loss value decreases, the prediction of Q-values may become more accurate.

The reinforcement learning module determines the policy of the reinforcement learning model and recommends a topic S6030.

The reinforcement learning module recommends training email topics for the user to view based on the policy. For example, the reinforcement learning module uses an ε-greedy policy, which may be designed to maintain a balance between exploration and exploitation. In the E-greedy policy, the value of ε may adjust the probability between recommending a random topic (exploration) and recommending the topic with the highest Q value (exploitation).

Recommendation of a random topic with a probability of ε (exploration) Recommendation of the topic with the highest Q value with a probability of (1−ε) (exploitation)

For example, when ε=0.5, the reinforcement learning module may recommend a random topic with a 50% probability and the topic with the highest Q value with the remaining 50% probability. This policy allows reinforcement learning modules to explore various topics during the initial stages of training and enables them to increasingly focus recommendations on optimal topics as training progresses. Through exploration, reinforcement learning modules may test new topics and, by leveraging this, recommend topics that elicit positive user responses more frequently. This maximizes the performance of personalized topic recommendations.

The reinforcement learning module measures the reward based on the topic S6040.

The recommended topic is provided to the user via an LLM Agent as a training email, and the reinforcement learning module may measure the reward based on the user's response. For example, if the user clicks the email or opens the link, a positive reward (+1) is given, and if they do not click, a reward of 0 may be applied. This reward may be used as an indicator to evaluate whether the system accurately predicted the user's interest. The reward may comprehensively reflect various factors, not just the user's click.

The followings are examples.

Engagement: +1 when the user clicks or opens the email

Diversity: Rewards increase as repetition of the same topic decreases.

Timeliness: The newer the issue topic, the higher the reward (e.g., year-end tax settlement topic during year-end tax settlement season)

This reward system enables the topic selection module to recommend topics reflecting user interests more frequently and may continuously optimize the performance of the reinforcement learning model.

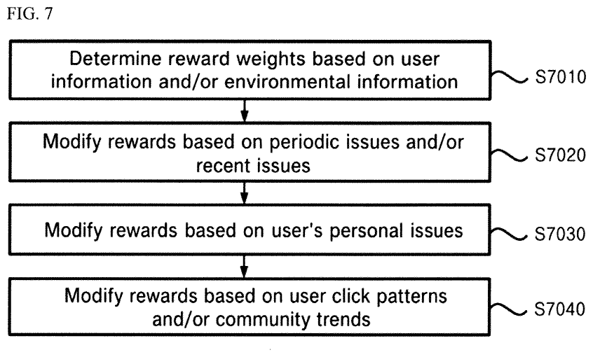

FIG. 7 illustrates a reward function to which this specification is applicable.

Referring to FIG. 7, the reward function of a reinforcement learning-based training email topic automatic generation system may be structured to grant rewards by comprehensively evaluating user behavior and environmental factors. For example, the reward value may be dynamically determined by reflecting the user's behavior patterns, recent issues, regular issues, and individual user characteristics.

The reinforcement learning module determines reward weights based on user information and/or environmental information S7010.

The reinforcement learning module may determine initial reward weights by verifying user information and environmental information through the DB. For example, environmental information includes personal user characteristics such as date, user location, and user job. This information provides important foundational information for topic recommendations and may be utilized as basic data to provide customized topics to the user.

Through date information, the reinforcement learning module may identify the current season, year, and specific event periods (e.g., year-end tax settlement, summer vacation), which may act as key variables that may affect user interests. User information reflects personal characteristics such as the job function, years of experience, region, and gender, which may be utilized to understand user behavior patterns and recommend customized topics.

For example, if the user is in the year-end tax settlement season, the reinforcement learning module may set a high reward weight for topics related to year-end tax settlement. Conversely, if it is the summer vacation season, topics related to travel or security may receive higher rewards.

The reinforcement learning module modifies rewards based on periodic issues and/or recent issues S7020.

The reinforcement learning module may increase or decrease rewards based on periodic and recent issues through the database. For example, periodic issues refer to issues that occur periodically by country or region, and may include year-end tax settlements, vacations, paydays, security checks, etc. These periodic issues are important factors that allow for easy prediction of user interest, and the reinforcement learning module may automatically detect them and increase the reward value of related topics.

Recent issues include real-time news, social media trends, and recent phishing cases, and the reinforcement learning module may adjust reward values by evaluating whether these issues are recent trends. For example, if recent phishing attacks are occurring in a specific manner, the reward value of the corresponding topic may increase.

Through this, the reinforcement learning module may improve the accuracy of topic recommendations by reflecting the likelihood that users will be interested in recent trends.

The reinforcement learning module modifies rewards based on the user's personal issues S7030.

The reinforcement learning module may increase or decrease reward values based on the user's personal issues through the database. The user's personal issues include their job function, years of experience, welfare-related information, and history of security breaches, which may be used to recommend topics tailored to the user's characteristics. For example, if the user works in the financial industry, reward values for topics related to financial fraud or security may be set higher.

Additionally, if the user has a history of security breaches, the reward for security awareness training topics may increase; if the user's job function is IT-related, reward values for topics related to the latest technology trends or cybersecurity may be higher. These personalized rewards enable the system to recommend user-specific topics more accurately.

The reinforcement learning module modifies rewards based on user click patterns and/or community trends S7040.

The reinforcement learning module may ultimately adjust reward values based on user click patterns and community trends through the database. For example, the reinforcement learning module may analyze topics that users have frequently clicked in the past and increase the reward values for topics with high click-through rates. This may improve the accuracy of personalized topic recommendations by reflecting user interest.

Additionally, by reflecting community trends, the reward values for topics mentioned in recent social media issues or news may be further weighted. For example, if there is a security issue that has recently become a hot topic on social media, the reward value for that topic may increase. This enables the provision of topics reflecting the latest trends to users and allows users to quickly acquire the latest information.

Referring again to FIG. 6, the reinforcement learning module stores experiences based on rewards and samples mini-batches S6050.

The reinforcement learning module may store user responses (Transition: s, a, s′, r) in a replay memory. The replay memory is a storage that allows the system to store and learn from past user response data. For example, topics clicked and unclicked by the user, as well as the click-through rates for each topic, may be stored.

The main advantage of the replay memory is that it allows for random sampling regardless of chronological order. At regular intervals, N random experiences may be sampled through mini-batch sampling and utilized for Q-Network training. For example, 66 experiences may be randomly sampled from 1,000 past experiences for training. This mini-batch training ensures diversity in the training data and prevents the system from relying on specific users or topics. In addition, replay memory-based learning can improve the stability of Q-Network training.

The reinforcement learning module updates the reinforcement learning model S6060.

The reinforcement learning module may update the Q-Network based on experience data learned through mini-batch sampling. For example, the TD (Target) value is calculated for each sample to estimate the expected value up to future rewards, and the Q-Network weights may be adjusted by minimizing the loss function.

Here, the calculation of TD (Target) may be defined as follows:

TD(Target)=Reward+Γ×Q(s′,a′)

Here, γ (discount rate) determines the importance of future rewards, and learning stability may be ensured by synchronizing the target network (θ_target) with the Q-Network (θ) at regular intervals. The ε value may also be gradually reduced to decrease the probability of random recommendations and increase the probability of optimal topic recommendations. Through iterative learning, the reinforcement learning module enables the system to continuously improve the performance of user-customized topic recommendations.

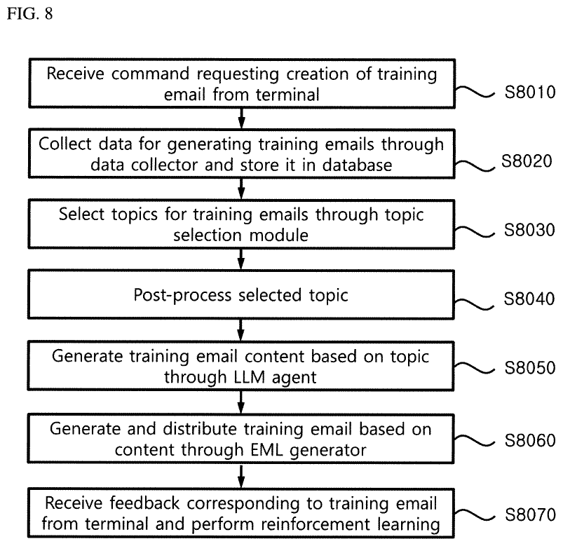

FIG. 8 illustrates a method for automatically generating a training email to which this specification is applicable.

Referring to FIG. 8, the system 300 may automatically generate training emails by applying reinforcement learning described above, and deliver them to users through a terminal.

The system receives a command requesting the creation of a training email from the terminal S8010.

The customer transmits a request for training email creation to the system through the terminal, and the system may also receive customer data. For example, customer data may include user characteristics (occupation, age, country) and past training performance (open rate, click-through rate). This data provides basic information for training email generation and may establish a foundation for providing customized training emails to user groups. The more extensive and detailed the customer data, the more accurate the topic selection. For example, the latest financial fraud prevention topics may be selected based on data from a financial industry user group. Conversely, if data is insufficient, general security training topics may be selected. If necessary, the system may acquire additional data through S8020.

The system collects data for generating training emails through a data collector and stores it in a database S8020.

If necessary, the data collector may collect data on the latest security issues, phishing techniques, and user interest topics required for generating training emails from various sources (e.g., websites, social media, news, blogs, etc.) through the Internet. This data may be updated regularly. The collected data may be refined to be utilized for topic selection. The collected data is then stored in a database.

For example, when generating training emails for financial professionals, the data collector may automatically collect recent financial fraud cases, cloud security issues, and phishing email templates. This data provides the basis for effectively selecting topics for training emails to be provided to users.

The system selects the topics for the training emails through a topic selection module S8030.

The topic selection module applies a reinforcement learning algorithm based on the collected data to select the optimal training email topic.

The system post-processes the selected topic S8040.

The system may further include a topic post-processing module and an image update module. The topic post-processing module may determine whether additional HTML formatting or images are required for the selected topic. Furthermore, if HTML analysis is required, the system may automatically generate HTML structures or modify existing HTML templates in a similar manner to the LLM agent. If images are required, the image update module may create an image appropriate for the topic or retrieve the image from a database.

For example, for a topic on financial fraud prevention, it is possible to include the financial institution's logo in HTML format and add an image depicting a recent financial fraud case. These HTML and image settings are configured to maximize user engagement.

The system generates training email content based on the topic through the LLM agent S8050.

The LLM agent may generate training email content based on the selected topic and HTML and image information transmitted from the topic post-processing module. The LLM agent automatically generates an email subject and body using large-scale language models such as GPT, Llama, and Deep Seek, and may also generate customized content that reflects user characteristics and the latest security threats.

This separation of topic and content generation, where reinforcement learning is applied solely to topic selection, is designed to address the inherent limitations of reinforcement learning. The reinforcement learning is an algorithm that dynamically learns within a state, action, and reward structure, wherein an action selected in a given state is evaluated for performance through a reward, and this evaluation is optimized through learning. However, while content generation relies on the context and grammar of the text, as well as the creativity of the message to be delivered to the user, reinforcement learning struggles to effectively learn this complex language generation process. In particular, text generation allows for an infinite number of expressions, and user responses (views, clicks, etc.) cannot clearly assess sentence-level performance, making it unsuitable for reinforcement learning. On the other hand, topic selection may be directly evaluated through quantitative metrics (click-through rates, view rates), and topic performance may be optimized through reinforcement learning for each user group. Therefore, the present system applies reinforcement learning only to topic selection, while content generation is performed by the LLM agent based on fixed prompts. This maximizes the efficiency of reinforcement learning and maintains the stability of content generation.

Table 1 below provides an example of prompts for the LLM agent to generate training email content.

Referring to Table 1, the prompts may be configured to automatically generate email subject and body (contents) in JSON format.

TABLE 1
Please select an email subject that people related to the following
reference data would click on and an email content corresponding to that
subject. The subject and the email content corresponding to the subject
should be written in Korean, and the data format should be in the
following json format. { “subject” : “”, “contents” : “” } Reference data :

Table 2 below illustrates the data returned when the LLM agent generates training email content.

Referring to Table 2, the returned data includes the email subject and body (contents) in JSON format, and may be dynamically generated based on user characteristics or topics.

TABLE 2
{ “subject”: “Restructuring the workforce and future direction due to AI
adoption”, “contents”: “Hello, our members.\n\nIt is with a heavy heart that we
share with you a significant change in our company. Kakao Corporation recently
implemented an organizational restructuring to enhance AI-based services and
maximize efficiency. As part of this process, new recruitment has been
temporarily suspended, and approximately 10% of our workforce has been
advised to resign.\n\nThis decision was not made lightly and is the result of
intense internal discussion. We ask for your understanding that this is an
inevitable measure to respond to the rapidly changing market and technological
environment and to ensure the company's sustainability and
competitiveness.\n\nDetails and support measures related to this measure will be
announced separately, and all procedures will be conducted as transparently and
fairly as possible. We will also provide practical assistance to those affected by
this change through various solutions, including career transition support,
psychological counseling, and reemployment programs.\n\nThe transition to AI
and efficiency is a new era that we must prepare for together. This makes
cooperation and trust with our remaining members even more important. We
believe this change will enable us to emerge as a stronger and more flexible
organization.\n\nWe understand you may have many concerns and questions.
Please feel free to contact the HR team or reply to this email at any time, and we
will be happy to answer them.\n\nThank you.\n\n- Best regards, Management
Group -” }

The system generates and distributes a training email based on the content through an EML generator S8060.

The content generated by the LLM agent may be converted to EML file format using the EML generator.

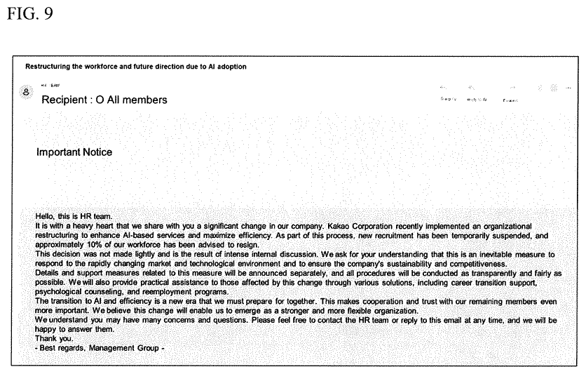

FIG. 9 illustrates an example of a training email to which this specification is applicable.

Referring again to FIG. 8, the EML file is a standard format usable by email clients (e.g., Outlook, Gmail), and may include the email subject, body, image, link, etc. The HTML format is automatically optimized for each client. The generated EML file may then be sent to training target customers through an email distribution service.

The system receives feedback corresponding to the training email from the terminal and performs reinforcement learning S8070.

The system collects user responses to the training email (e.g., views, clicks, etc.) and analyzes the training result data received from the customer. Here, the collected feedback may include the followings.
1 Customer Information: Company Name, Company Job Title, Average Years of Experience, etc.
2. Clicked Customer Data: Years of Experience [optional], Email Open Time [optional]
3. Click-Through Rate: Click-Through Rate of Training Conducted by the Client [optional], Percentage of Clicked Customers by Year of Experience (n % for 10 years, m % for 5 years, etc.) [optional]

This feedback data may be refined and passed to the topic selection module to be utilized for training.

For example, the topic selection module may evaluate the performance of each topic based on feedback and update the Q-value. Topics with high Q-values are prioritized for subsequent training, while topics with low performance are gradually eliminated.

Furthermore, this specification can significantly reduce training system maintenance costs by minimizing user intervention. Through automated topic selection, email generation, user response analysis, and performance learning, the system can automatically generate and improve optimal training emails without the need for an administrator. This represents a clear structural and functional difference compared to existing manual training systems. In particular, automatically providing user-tailored training through reinforcement learning enables real-time performance, automation, and individual optimization, which were previously unattainable.

The above-described specification may be implemented as a computer-readable code on a program-recorded medium. A computer-readable medium includes any type of recording device that stores data readable by a computer system. Examples of computer-readable media include hard disk drives (HDDs), solid-state disk drives (SSDs), silicon disk drives (SDDs), ROMs, RAMs, CD-ROMs, magnetic tapes, floppy disks, optical data storage devices, and even those implemented in the form of carrier waves (e.g., transmission through the Internet). Therefore, the above detailed description should not be construed as limiting in any respect and should be considered illustrative. The scope of this specification should be determined by a reasonable interpretation of the appended claims, and all modifications within the scope of equivalents of this specification are intended to be included within the scope of this specification.

Furthermore, while the above description focuses on services and embodiments, these are merely examples and are not intended to limit this specification, and those skilled in the art will appreciate that various modifications and applications not illustrated above are possible without departing from the essential features of the services and embodiments. For example, each component specifically described in the embodiments may be modified and implemented. In addition, the differences related to these modifications and applications should be construed as being included within the scope of this specification as defined in the appended claims.

What is claimed is:

1. A method for performing reinforcement learning to generate a topic for a training email by a server, the method comprising:
obtaining a user state through a database,
the user state
including characteristic information of a user to whom the training email is delivered;
inputting the state into a reinforcement learning model (Q-Network); and
determining a policy of the reinforcement learning model and recommending a topic for the training email.

2. The method of claim 1, comprising:
measuring a reward based on the topic of the training email, wherein the reward is determined in relation to the user's feedback; and
updating the reinforcement learning model based on the reward.

3. The method of claim 2, wherein the policy of the reinforcement learning model is based on a ε-greedy policy.

4. The method of claim 3, wherein the policy of the reinforcement learning model recommends a random topic with probability ε and recommends the topic with the highest Q value with probability (1−ε).

5. The method of claim 2, wherein the updating of the reinforcement learning model based on the reward comprises:
storing the user's response as an experience in a replay memory based on the reward;
mini-batch sampling the experience using the replay memory; and
updating the reinforcement learning model based on the mini-batch sampling.

6. The method of claim 2, further comprising:
generating content for the training email using the topic of the recommended training email; and
generating the training email based on the content.

7. The method of claim 6, wherein the measuring of the reward based on the topic of the training email further comprises
determining the weight of the reward based on user information or environment information.

8. A server performing reinforcement learning to generate a topic for a training email, the server comprising:
a communication module;
a memory; and
a processor that is for functionally controlling the communication module and the memory,
wherein the processor obtains a user state through a database, the user state including characteristic information of a user to whom the training email is delivered, inputs the state into a reinforcement learning model (Q-Network), determines a policy of the reinforcement learning model, and recommends a topic for the training email.
